(19) United States
(12) Patent Application Publication
(10) Pub. No.: US 2010/0121872 A1
(43) Pub. Date: May 13, 2010

(54) PERSONALLY CONTROLLED STORAGE AND TESTING OF PERSONAL GENOMIC INFORMATION

(76) Inventor: Sundar SUBRAMANIAM, Cambridge, MA (US)

Correspondence Address: GLOBAL IP SERVICES, PLLC, 10 CRESTWOOD LANE, NASHUA, NH, 03062, US

(21) Appl. No.: 12/532,998

(22) PCT Filed: Mar. 27, 2008
(86) PCT No.: PCT/US08/58443

§ 371 Date: Sep. 25, 2009

Related U.S. Application Data
(63) Continuation-in-part of application No. 11/752,530, filed on May 23, 2007.
(60) Provisional application No. 60/908,296, filed on Mar. 27, 2007.

(51) Int. Cl. G06F 17/30; G06F 15/16

(52) U.S. Cl. 707/769; 709/223; 707/E17.014

(57) ABSTRACT

An electronic system, method, and service is disclosed for storing subjects' genomic and medical information on portable storage devices to be used for private disease diagnosis and for subject-controlled participation in research queries. Using a computer with network access, subjects conduct private disease diagnosis and disease forecasting by downloading genetic queries and running the queries against private genomic data stored on the portable storage device. When participating in a subject-controlled research program, subjects are provided the capability of joining a peer-to-peer network and the choice to decide whether to participate in queries submitted by researchers over the network to subject network members. When subject network members decide to participate in a submitted query, they download the query, run the query against their private data, and anonymously submit the results back to the network.

### CROSS REFERENCE TO RELATED APPLICATIONS

This patent application claims priority to and the benefit of U.S. patent application Ser. No. 11/752,530, filed May 23, 2007, and U.S. provisional patent application 60/908,296, filed Mar. 27, 2007, the entire contents of each of which are incorporated by reference for all purposes into the present application.

### FIELD OF THE INVENTION

The invention relates to the secure possession and analysis of an individual's personal genetic data.

### BACKGROUND

Governments, corporations, universities, and other institutions are increasingly interested in using genetic information and electronic medical records to advance research into the causes of disease and into potential cures. Simultaneously, individuals are increasingly concerned about maintaining the privacy and security of their personal medical and genetic information. One of the most significant challenges facing the adoption of electronic medical records and integrating personal genetic information in such systems is the difficulty of keeping these records private. The task becomes even more complex with the additional desire to provide access to personal data for research purposes.

This dilemma becomes more pressing as the cost of genomic testing and sequencing falls and as genomic records for individuals become more widely available. While technology has been developed to permit the electronic storage of genomic and medical records, the utilization of electronic medical records and the sharing of this data for research purposes has been limited by the numerous obstacles faced in ensuring the privacy of data and by the subjects' understandable reluctance to share their data. Many individuals are interested in learning whether they have inherited specific diseases but are legitimately concerned and especially vulnerable to discrimination if, for example, employers and insurers were to receive their private genomic information.

Originally, medical records were stored utilizing paper record keeping systems, and often still are. While electronic medical record systems have been developed by numerous companies and adopted by various institutions, the problem remains that current medical information collection, storage, and sharing methods have many inherent problems that make their utilization and adoption problematic. In addition, because new genomic tests that can predict the susceptibility of individuals to future disease are continually being developed, there is an even greater risk of discrimination to individual subjects if their personal genomic and medical data were to be shared either directly or indirectly with current or future employers, insurers, and others.

Several types of solutions have been proposed that try to ensure a subject's anonymity or to provide subjects with some level of control over who may access their personal medical information. For example, U.S. Pat. No. 6,732,113 to Ober et al. discloses a method for creating a unique alias associated with each individual identified in a health care database. In the field of genetic testing, U.S. Pat. No. 7,089,498 to Rathjen et al. discloses a method for electronically storing the genetic information of individuals in a database and providing access for retrieval of the information by the individual from whom the genetic data were collected, after authenticating the data requester's identity.

U.S. Pat. No. 6,988,075 to Hacker discloses a system of storing patients' medical records on a medical information database via a medical information server connected to a network, giving patients the ability to access their medical record using browser software on any browser-enabled device connected to the network. Hacker further proposes giving patients the ability to authorize others to access or download their medical records, in whole or in part. Similar to Hacker, but specific to genomic data, U.S. Pat. No. 6,640,211 to Holden discloses a genetic banking system where the genetic profiles of individuals are stored in an accessible database and gives individuals the ability to authorize a third party user to access to their private genetic profile.

Thus, several existing methods have inherent security risks that flow from storing an individual's personal genomic data on a central, network-accessible database. Despite passwords and other controls created to limit what data is shared and with whom, subjects remain unable to maintain and keep physical control over their medical and genomic data and thus need to rely on system administrators, policies, and other methods not under their direct control in order to protect the security of their data and maintain the privacy of their identity. In addition, centrally stored databases that provide internet access to others so that they can view, edit, copy, or conduct research with the data have the inherent problem of a single source of failure. If security is breached at the central database, or among the personnel maintaining the central database, as has happened, for example, with databases utilized for storing credit card information, then everyone who had their data stored centrally is vulnerable. Another significant drawback is that no matter how trusted the third party, whenever individuals provide these third parties with access to their personal genetic and medical information, they are leaving themselves potentially vulnerable to the third party or its employees possibly making a copy of their personal data, sharing their data without the subject's consent, selling the data, misplacing the data, or suffering some other security breach. An additional limitation is the high cost of building, maintaining, and securing a large central database to store the medical information of individuals. These costs become substantial when thousands or even millions of individual medical records are attempted to be stored centrally.

Other methods for storing medical information locally for use in emergency medical situations are also problematic. Early medical information storage devices were solutions such as military dog-tags or bracelets to indicate that the wearer has a specific medical condition or allergy. U.S. Pat. No. 6,747,561 to Reeves discloses a device worn on the body, preferably in the form of jewelry, a medallion or watch that stores an individual's medical history, as an improvement over the original dog-tag concept. Reeves mentions that his proposed device could be linked via the internet to a central website or database, but only for the purposes of augmenting the storage capacity of the portable device or for providing international access to a person's medical record information. Other similar solutions have been proposed (see, for example, U.S. Pat. Nos. 5,659,741 and 5,197,763). Both utilize credit card sized medical cards designed to be kept by individuals in their wallets or on their person. The primary purpose of these previously proposed solutions is to provide critical medical information in the case of a medical emergency; for example, when the wearer is unconscious or otherwise unable to provide critical information when emergency medical treatment is required. Accordingly, they were designed to be easily identified and accessed by third parties without express authorization or consent by the individual, facilitating the compromise of any private information contained in the devices.

Thus, there is a need for enhanced security in systems and methods for storing and analyzing an individual's personal genetic and medical information.

### BRIEF SUMMARY OF THE INVENTION

The present invention addresses the need for security in the storage and processing of private genetic and medical information. It is an object of this invention to provide individuals with greater control over their personal genomic and medical information. The method provides individuals with access to genetic queries that they can download and run by themselves in private, and it facilitates the sharing of research queries and query results between researchers and individuals, while allowing each individual to maintain control over their personal data and choice in deciding whether to participate in queries.

Various aspects of the invention, which can be used separately or in combination, relate to portable data storage devices to store personal data; providing downloadable research queries to a computer with network access; running queries against the personal data on a computer; or providing individuals the opportunity to share query results (e.g. anonymously over a peer-to-peer network). The invention permits, for example, secure private testing to discover whether individuals have inherited genomic variations that cause or increase the risk of developing disease, and permits genomic research while maintaining the privacy of each individual and their data.

The invention provides methods for utilizing digitized personal genomic data that are not stored on a centralized server. In one aspect, the method includes providing a query on a network-accessible computer, such as a computer with internet access. In some embodiments, the network-accessible computer is a centralized server. In other embodiments, the network-accessible computer is a computer participating in a peer-to-peer network. The network-accessible computer permits individuals possessing their digitized personal genomic data to download the query from the network-accessible computer to, for example, a personal computer or other computational device. If an individual downloads the query, the query can be run against the individual's own digitized personal genomic data to conduct a genetic analysis of the individual's data. In some embodiments, the individual also possesses digitized medical information and the query is run against both the digitized personal genomic data and against the other medical information.

Thus, an analysis of the individual's data can be conducted locally, e.g. on the individual's own computer, without any need to transmit the individual's genetic sequence over the network or to store the individual's genomic or medical data on a centralized server. Nevertheless, the results of the query can optionally be communicated once a query has been run. Accordingly, in some embodiments, the method includes both providing the query on a network-accessible computer and receiving aggregate information from results of running the query on the digitized personal genomic data from individuals agreeing to participate in the query. The aggregate information can, for example, be received from aggregating nodes and, in preferred embodiments, does not identify the individuals whose aggregate information is received.

In another aspect, the invention provides a method for individuals to perform an analysis of their own digitized personal genomic data, which are not stored on a centralized server. The method includes downloading a query from a network-accessible computer (e.g. an internet-accessible computer, such as a centralized server, for example, or a computer connected to peer-to-peer network) onto a personal computer or other computational device, and running the downloaded query on the individual's own digitized personal genomic data. Thus, the individual conducts a genetic analysis of his or her own digitized personal genomic data. In some embodiments, the downloaded query is run after the personal computer or other computational device has been disconnected from the network, thus providing an optional security enhancement. In selected embodiments, the results of the downloaded query are subsequently transmitted, e.g. to a centralized server, to an aggregating node, and/or over a peer-to-peer network. One preferred embodiment provides for a transfer, controlled by the individual, of query results from his or her personal computer to a secure query result database accessible to individuals such as medical providers selected by the individual.

In certain embodiments, the digitized personal genomic data are stored on a portable storage device, such as, for example, a USB drive or an iPod™ device, which can optionally further store a medical record for the individual, permitting the downloaded query to be run against the individual's digitized personal genomic data and against the medical record. In particular embodiments, the portable storage device is connected to the personal computer or other computational device before running the downloaded query. If results of the downloaded query will be transmitted, in some embodiments the portable storage device is disconnected from the personal computer or other computational device before transmitting the query results.

Accordingly, in another aspect, the invention provides portable storage devices useful in the practice of the invention. The portable storage device includes digitized personal genomic data and, in some embodiments, also includes medical information. The portable storage device includes software that, when the portable storage device is connected to a computer, checks to see whether the computer is connected to a network. In certain embodiments, the software prompts a user to disconnect a detected network connection. In some embodiments, the software automatically disconnects a detected network connection. In specific embodiments, the software locks the digitized personal genomic data if a network connection is detected.

The features, utilities and advantages of the various embodiments of the invention will be apparent from the following more particular description of embodiments of the invention as illustrated in the accompanying drawings.

### BRIEF DESCRIPTION OF THE DRAWINGS

FIG. 1 illustrates an exemplary embodiment of a “personal query method” in which individuals privately run their personal genomic data against a downloaded query. FIG. 1A shows an individual providing his or her medical information and a blood, saliva, hair, or tissue sample for sequencing and receiving their sequenced DNA and medical information digitally stored on a portable storage device, such as a USB card. FIG. 1B shows a central server that contains a list of queries (tests) that individuals can download onto his or her computer. FIG. 1C shows an individual connecting to the central server via the internet and downloading genetic queries onto his or her computer. FIG. 1D shows an individual disconnecting the computer's network connection and inserting a USB storage device that contains his or her genetic information. FIG. 1E shows an individual running the downloaded query against the genetic information.

FIG. 2 illustrates an exemplary embodiment of a “peer-to-peer researcher query method,” in which researchers submit queries to the network, and individual network members who choose to participate can then download and run queries against their own personal data and submit the results anonymously back to the researcher. FIG. 2A shows both a researcher and individual joining the peer-to-peer genomic network. FIG. 2B shows a researcher creating a research query and submitting it to the peer-to-peer genomic network. FIG. 2C shows an individual network member deciding whether or not to participate in the researcher's query. FIG. 2D shows a network member who chooses to participate, downloads the researcher's query, disconnects his or her computer's network connection, inserts a USB storage device and runs the query against his or her personal data. FIG. 2E shows a network member who has completed running the researcher's query, disconnected the USB storage device, and reconnected the network connection. FIG. 2F shows the participating network member submitting his or her query results to the peer-to-peer network, which optionally forwards the data via aggregating nodes. FIG. 2G shows aggregating nodes forwarding aggregated query results back to the researcher who initiated the query.

### DETAILED DESCRIPTION OF THE INVENTION

The invention described herein provides a unique solution to the conflict between privacy and the desire to use personal genomic and medical information in order to conduct research, perform medical evaluations, and to make personal health, lifestyle, and other important personal decisions based on one's own private genomic information. The invention provides a new method, system, and approach for conducting private disease diagnosis and conducting research. In some embodiments, the invention also provides for the storage of private genetic and medical information on portable digital storage devices, allowing individuals to download and run queries privately against their genomic information, and, in particular embodiments, enabling individuals to participate in researcher-initiated queries over a peer-to-peer network.

Methods and systems in accordance with the invention offer a means for a subject's privacy and control over access to his or her private data. The present invention differs significantly from various current methods for storing and using an individual's personal genomic information. Generally, the present invention permits individuals to perform all tests on their own computers and to share test results only if they choose to do so. Furthermore, third parties generally are never given access to the private data or authorization to perform tests using the personal information. Rather, third parties are only given access to anonymous test results.

### I. Portable Storage Devices

In one aspect, the invention provides portable storage devices permitting an individual to retain control, in particular, physical control, over access to his or her genetic and medical information. An individual whose genetic information has been determined receives the genetic information on a portable storage device, such as a USB card, a removable USB drive (such as an iPod™ device), or any large digital storage medium such as a computer chip, flash memory stick or other digital storage medium containing their sequenced genetic information.

The genetic information optionally is combined and integrated with personal medical information. The personal medical information can be collected, transferred and incorporated from multiple sources, including paper and/or online medical questionnaires completed by the individual or medical records provided via paper and/or electronic formats. Medical record information from other sources can be audited and corrected or updated as required.

Security of personal data is enhanced by providing an embedded software algorithm in the portable storage device that when connected to a computer, by default automatically checks to see whether the computer is connected to a network. In one embodiment, the individual can choose a graded level of security for their data. At its highest setting, if a network connection is detected, it prompts the user to disconnect the network connection. It may also provide the additional security steps of disconnecting the network connection, for example, if the user disregards the automated prompt, and/or locking the data stored in the storage unit until the network connection is disconnected. At lower security settings, individuals may connect the storage device to a computer while there is a network connection.

Data security optionally is further enhanced by a requirement for unique access identification supplied by the individual, such as a subject-supplied username and password in order to access, download or view a subject's genomic and medical data. Other forms of unique access identification that can be incorporated include, for example, alpha-numeric pass phrases, smart cards, biometric samples, bar codes and RFID devices.

The portable storage devices of the invention are a significant improvement over earlier portable medical information storage devices, which were designed not for the secure storage and use of private genomic data, but to provide quick and unhindered access to medical information in the event of a medical emergency. At least in part as a result of this key difference in design principle, those earlier storage methods suffer critical privacy and security disadvantages compared to the present invention. Some of the specific advantages of the portable storage devices of the present invention include:
a) The portable storage devices of the present invention need not be designed for simple and easy identification and discovery by emergency workers and others, thereby avoiding the resulting security and privacy limitations. In contrast, unconscious subjects or individuals who might misplace a portable device designed for storing medical emergency information are particularly vulnerable that the privacy of their information could be compromised.
b) The portable storage devices of the present invention need not be designed for easy access and retrieval of the subject's private medical information in an emergency situation. In contrast, systems for use in medical emergencies are by design intended to be used so that no consent or private personal password created or controlled by the unconscious patient is required to retrieve the medical information.
c) Unlike some solutions to the medical emergency problem, the portable storage devices of the present invention need not transmit personal medical information from the device to a caregiver over a network, the internet or, as proposed by U.S. Pat. No. 6,747,561, over a wireless connection. In contrast, devices and methods that transmit data suffer the risks that security is breached while the medical data is being transmitted from the device over a network and or is breached at any time after the data has been transmitted to and stored at the recipient's location.
d) Unlike some solutions to the medical emergency problem, the portable storage devices of the present invention need not trigger the transmission of additional supplemental personal medical information to emergency medical workers and others from a central database. Solutions to the medical emergency problem that provide for data transmission have the inherent weakness of having multiple sources of failure. Security could be breached while the medical data is being transmitted, by having a breach at the central data storage location, or by having a breach at the recipient's data storage system or location.

In one embodiment, a portable storage device according to the invention also includes embedded software providing an individual's computer the ability to communicate with a network-accessible computer such as a centralized server to select and download queries from the server. In another embodiment, a portable storage device according to the invention includes embedded software providing an individual's computer to which the device is connected the ability to access the genomic and other medical information stored on the device. In another embodiment, a portable storage device according to the invention includes embedded software providing an individual's computer the ability to run a downloaded query against personal genomic information on a personal computer.

### II. Methods

The invention disclosed herein provides improved methods to utilize personal genomic and electronic medical data while enhancing security and ensuring the privacy of each individual's genomic and medical information. Although it is preferred that these methods be performed in conjunction with a portable storage device as described previously, the methods can also be performed with other systems providing subject-controlled access to personal genomic information.

II.a. Personal Query Methods

Individual subjects can use their own genetic information to run private queries to learn whether they have inherited specific genomic profiles that are known to cause, correspond to, or forecast the development of specific medical conditions and/or diseases. Each individual person can then decide for themselves how they want to use the information and whether they want to share the information. For example, a person who has inherited a genomic profile that makes them especially susceptible to heart disease may want take early preventative actions through lifestyle modification and/or early pharmaceutical and/or other medical intervention in order to delay its onset or avoid getting the disease entirely.

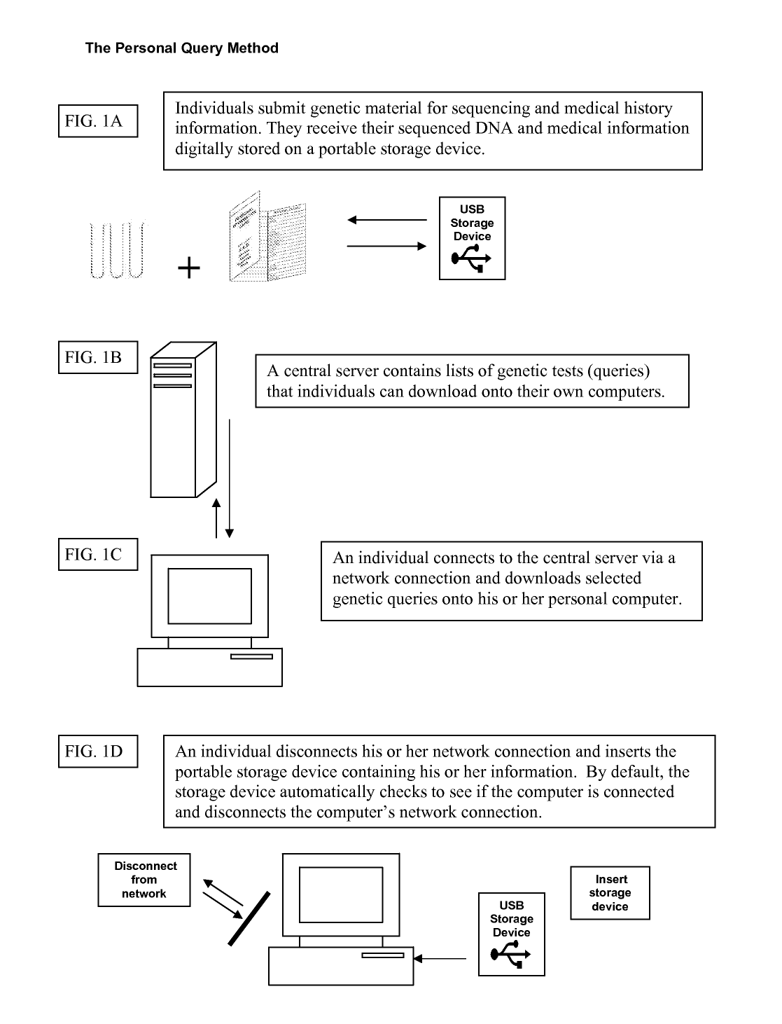

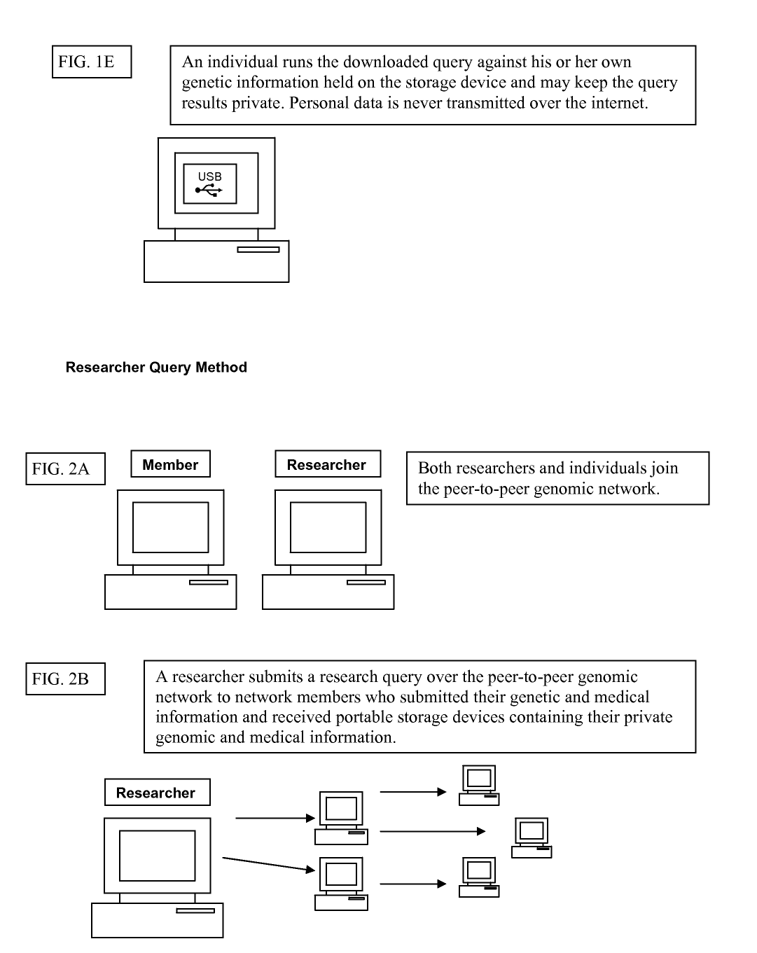

One embodiment of the “personal query method” is illustrated in FIG. 1. In this exemplary embodiment, a portable storage device is used to store an individual's genomic information and medical record. As shown in FIG. 1A, an individual provides a sample of their genetic material, such as blood, for genomic sequencing and may also provide their medical history for inclusion. They then receive their digitized genetic and medical information stored on a portable storage device, such as a USB card or removable USB drive (such as an iPod™ device). As shown in FIG. 1B, in addition to receiving their genomic information, the individual receives a URL with instructions to a central repository of genetic tests and queries providing, for example: (a) a proxy server address, (b) user logon information, (c) lists of genetic tests or queries to be accessed, and (d) a URL link to download any genetic test in response to said configuration information and query request. The repository of genetic queries is accessed by generating a URL link with its address and fields containing the information identifying the content portion and the genetic test. The generated URL link is communicated to an application used for identifying a test and downloading the test.

As shown in FIG. 1C, in order to perform a personal query and analysis, a subject must download at least one genetic test onto his or her personal computer (or other computational device) “computer” that is able to access a network and download data. As shown in FIG. 1D, once the query is downloaded, the subject can disconnect from the network and insert the storage unit containing his or her genetic information. As shown in FIG. 1E, the subject then privately runs the downloaded query against his or her own data. The network-accessible computer with the repository of queries, the personal computer, or the storage unit may also include software and interface means to notify an a subject where he or she can get additional information on a specific disease if the individual discovers that he or she had inherited a genomic pattern known to cause the disease. In another embodiment, the network-accessible computer with the repository of queries includes software to track an individual's previous query downloads to suggest updated queries as they are developed for a disease in which the subject has shown a particular interest, or to suggest updated disease information, websites, medical content, or information from providers of therapies for the disease.

Personal genomic and medical information need not be sent over the network. Indeed, the personal genomic information is not stored at a central location, database, or server. With the personal query method, in one embodiment, only the queries are located at a central location. It is understood, however, that the queries need not be stored at a central location. Rather, the queries can be located on one or more different network-accessible computers, accessible by the person with his or her own genetic and/or medical information. Only the tests, not the genetic data, are downloaded over the network to each individual's computer, in order to perform and run the query against the genetic data held on the portable storage unit or computer. The actual personal genetic information always remains on each individual's portable storage unit or personal computer, not on a centralized server.

II.b. Research Query Methods

An additional exemplary embodiment enabled by the present invention is the creation of an online search engine for use by genetic researchers and others. Queries from researchers can be communicated to individuals possessing their genomic sequences and their anonymized responses to the queries, preferably in an aggregated form, can then be returned directly or indirectly to the researcher. A non-limiting, exemplary embodiment is described below as the “peer-to-peer researcher query method.” In addition to individuals downloading tests and performing personal queries based on their own genomic data, another valuable component of this infrastructure and method is the ability to run queries against this data which can be aggregated for research and other purposes.

In the peer-to-peer researcher query method, when each individual receives a portable genomic and medical record storage device, he or she optionally also receives software that permits him or her to join and participate in the peer-to-peer genomic network. As membership to the genomic peer-to-peer network grows, and as individual network members become more comfortable with participating in queries, sharing query results, or automating their participation, the network can perform the function of and become an online search engine for the human genome.

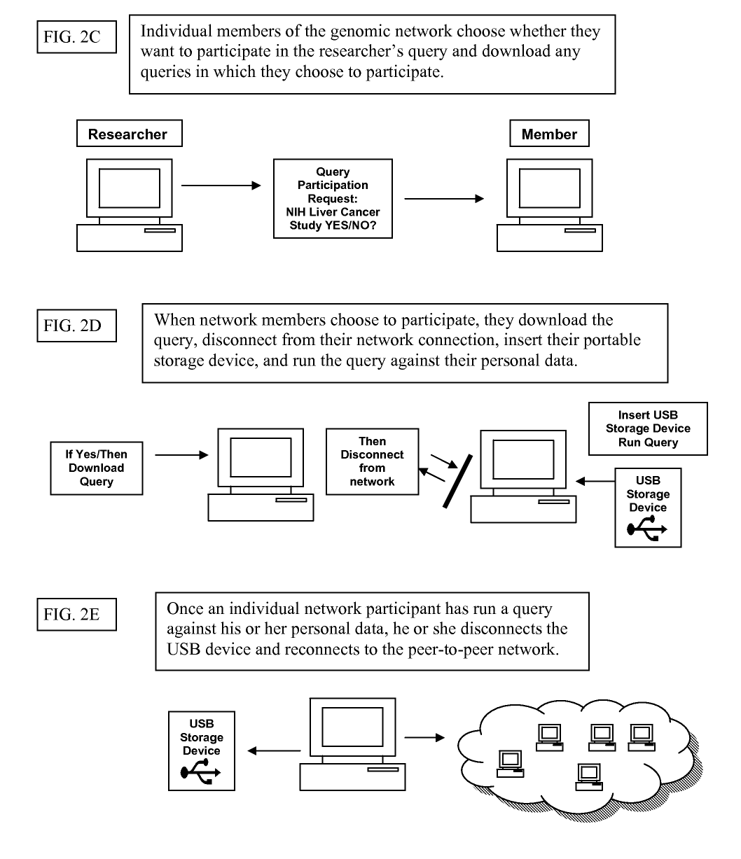

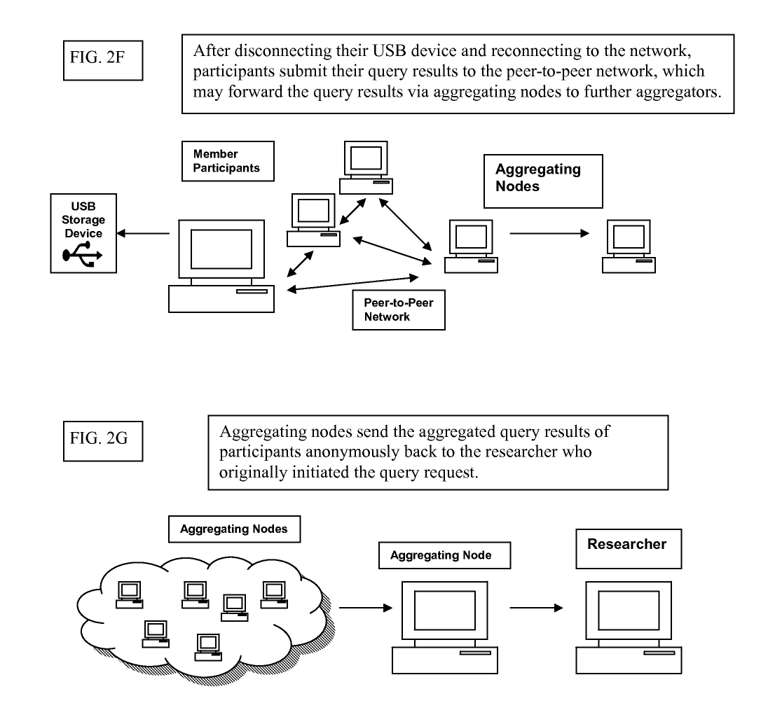

An exemplary approach is shown in FIG. 2. In FIG. 2A, both researchers and individual participants are provided software that allows them to join the peer-to-peer genomic network. Researchers must join the peer-to-peer network in order to submit queries to the regular network members. Regular network members are made up of individuals who joined the network after receiving their own portable storage devices following submission of their genetic material and medical information. Each individual network member is provided with options during installation of his or her personal genomic record asking whether he or she wants to participate in queries, from whom query requests will be accepted, for which purposes, and for which diseases. A person for example can configure his or her peer-to-peer genomic network participation to accept all queries, or only queries about pancreatic cancer, or queries only from a specific university, institution or group of institutions.

As shown in FIG. 2B, a researcher creates a research query and submits their credentials and query to the peer-to-peer network. The query incorporates a genetic test and may also access a digitized medical record and/or pose one or more questions to be answered by an individual participating in the query. As shown in FIG. 2C, individual members of the genomic network then choose whether or not they want to participate. As shown in FIG. 2D, if they choose to participate, they download the query onto their own computer, can disconnect from their network connection, insert their USB storage device, and run the query against their personal data. As shown in FIG. 2E, once an individual network participant has run a query against his or her personal data, the portable storage device can be disconnected, thus removing the personal data from the computer. The individual then reconnects to the network. As shown in FIG. 2F, after optionally disconnecting their USB device and reconnecting to the network, participants submit the query results back to the peer-to-peer network. In certain embodiments, the participants submit the query results to the peer-to-peer network via aggregating nodes that forward the query results to further aggregators. As shown in FIG. 2G, the aggregating nodes send the aggregated query results of participants anonymously back to the researcher who originally initiated the query request.

In a preferred embodiment, the peer-to-peer query method initially defaults at the highest level of security. The highest level requires that the data storage device and network are never connected to a computer simultaneously. However, network participants are provided the ability to adjust their security settings lower, so that both the data storage device and network connection can be simultaneously connected to their computer and to even automate their participation. Thus, in some embodiments, an individual can automate his or her responses to researcher queries by configuring and pre-authorizing some or all responses. In these embodiments, the individual's computer is programmed to automatically respond to preauthorized institutions or query types to automate the downloading, running, and submission of queries and query results. Exemplary pre-authorization criteria include, for example, query type, researcher, institution, disease, or “respond to all.”

Using this method, a researcher can create a query to be run against a specific population of members and to also run a query against control populations. For example, a researcher may want to find out if a particular gene variant contributes to obesity. The researcher would formulate a query looking for the presence of the specific suspect gene variant in a cohort of network members above a certain height/weight ratio. The height and weight information is stored on a portable storage unit, collected from medical records or via health information questionnaires submitted by clients when they submit their genetic material for sequencing. Individuals who agreed to participate in the obesity query would download and run the query on their own computers with the results merely answering whether they fit the search criteria and whether the gene variant was present or not. The query results would be aggregated over the peer-to-peer network and the researcher would receive the summary data from both the cohort of obese participants and the non-obese control group. A nonlimiting example of a successful query outcome could be having the researcher receiving aggregate data showing that 80% of the obese population, made up of 9,000 individuals, had the specific genomic profile that the researcher was looking for, while 90% of non-obese individuals, who numbered 15,000 participants, did not carry the genetic profile.

The researcher query methods allow research to be performed while maintaining the privacy of each individual. The illustrative “peer-to-peer researcher query method” takes advantage of a decentralized peer-to-peer network in which all peers act as equals, merging the roles of clients and server. Peers are responsible for hosting available resources and for making their shareable resources available to peers who request it. More generally, however, the inventive researcher query methods result in and maintain the capability of enhancing security and privacy by permitting queries to be run even while an individual's private genetic and medical information remains disconnected from the network. Thus, various methods of transmitting queries and query results can be accommodated in researcher query methods of the invention. The various approaches can be tailored depending on the circumstances. For example, with regard to the transmission of queries, the queries can be stored on a traditional server, such as a centralized server, rather than being communicated over a peer-to-peer network. Similarly, query results can be transmitted from a subject directly to a researcher, although indirect methods are often preferred to reinforce anonymity. With regard to the indirect methods, the results can be transmitted over a peer-to-peer network, as described in the “peer-to-peer researcher query method” or over a more traditional, non-peer-to-peer network. In either case, the results are preferably transmitted via one or more aggregating nodes.

Because the invention described herein was designed from the start to give individuals greater control, including physical control, over their personal genomic and medical data and to provide a secure way to run private queries and share query results, it provides many improvements and innovations. Several embodiments of the invention include at least one or more of these improvements. The improvements include:
a) Enhanced Security in the Acquisition and Storage of Genetic Information. Each person retains physical control of his or her own data and no personal genomic or medical data needs to be stored centrally. Individuals can submit genetic material for genomic sequencing and fill out a health questionnaire, provide their medical record, and/or provide a completed medical record release form, so that their medical information can be integrated with their genomic data. In return subjects may receive a portable storage device, such as a USB storage device, or any large digital storage medium such as a computer chip, flash memory stick or other digital storage medium containing their sequenced genetic information combined and integrated with their personal medical information.
b) Secure Procedure For Individuals to Perform Their Own Analysis. The invention provides a secure way for individuals to perform queries by letting individuals download genetic tests and privately run queries against their own genomic data. The individuals can connect to a server, download queries, disconnect the network connection, and run the downloaded queries against their private data. No private genomic data needs to be transmitted over the internet, submitted to someone else for testing, or stored centrally, and individuals can keep query results completely private.
c) Secure Procedure For Genetic Research. The invention permits a secure procedure for researchers to run queries against individuals who have indicated a willingness to participate in and respond to research queries over a peer-to-peer network. Researchers and individuals can join a peer-to-peer genomic network, with researchers submitting their queries to the network, and individuals anonymously downloading the queries they want to participate in and anonymously submitting only the query results back to the researcher over the peer-to-peer network.
d) Enhanced Data Security. The invention provides a secure method for performing a genetic analysis because the computer that runs the genetic analysis can be completely disconnected from a network before starting the analysis. Additional steps to improve the security of personal data include, for example, providing levels of security with the highest level utilizing a software algorithm, for example, an embedded software algorithm in the portable storage device, such that when the portable storage device is connected to a computer, the software algorithm automatically checks whether the computer is connected to a network. If there is a network connection, the software prompts the user to disconnect their network connection. The software may also provide the additional security steps of disconnecting the network connection if the user disregards the automated prompt and/or locking the data in the storage unit until the network connection is disconnected. Even if the portable storage device is discovered by an unauthorized user, the storage device optionally contains an algorithm requiring user authentication including knowledge of the individual user's username and password in order to access the data on the device. Further security can be achieved by encrypting query results sent over the peer-to-peer network.
e) More Effective Genetic Analysis. The invention permits constant upgrading and addition of improved and new genetic algorithms that can be downloaded and run as new discoveries are made and published. Furthermore, the invention provides a more cost effective means (i) to store personal medical and genomic data compared to the traditional method of creating and maintaining a large central database, and/or (ii) to perform genetic testing because a sample of genetic material only needs to be taken once and all subsequent tests are performed against the digitized information. In addition, the invention provides for the creation of an online genetic search engine allowing the submission and running of genetic queries that can lead to important discoveries on the causes of disease and lead to significant cures.

### INCORPORATION BY REFERENCE

The entire disclosure of each of the patent documents and scientific articles referred to herein is incorporated by reference for all purposes.

### EQUIVALENTS

The invention may be embodied in other specific forms without departing from the spirit or essential characteristics thereof. The foregoing embodiments are therefore to be considered in all respects illustrative rather than limiting on the invention described herein. Scope of the invention is thus indicated by the appended claims rather than by the foregoing description, and all changes that come within the meaning and range of equivalency of the claims are intended to be embraced therein.

What is claimed is:

1. A method for utilizing digitized personal genomic data not stored on a centralized server, the method comprising:
(a) providing a query on a network-accessible computer that permits individuals possessing their digitized personal genomic data to download the query from the network-accessible computer, wherein the query, if downloaded by an individual onto a personal computer or other computational device, can be run against the individual's own digitized personal genomic data to conduct a genetic analysis of the individual's own digitized personal genomic data.

2. The method of claim 1, wherein the network accessible computer is a centralized server.

3. The method of claim 1, wherein the individuals also possess their digitized medical information and the query can be run against the individuals' own digitized personal genomic data and their digitized medical information.

4. A method for utilizing digitized personal genomic data not stored on a centralized server, the method comprising:
(a) providing a query on a network-accessible computer that permits individuals possessing their digitized personal genomic data to download the query from the network-accessible computer, wherein the query, if downloaded by an individual onto a personal computer or other computational device, can be run against the individual's own digitized personal genomic data to conduct a genetic analysis of the individual's own digitized personal genomic data; and
(b) receiving aggregate information from results of running the query on the digitized personal genomic data from individuals agreeing to participate in the query.

5. The method of claim 4, wherein the aggregate information is received from aggregating nodes.

6. The method of claim 4, wherein the network accessible computer is a centralized server.

7. The method of claim 4, wherein the individuals also possess their digitized medical information and the query can be run against the individuals' own digitized personal genomic data and their digitized medical information.

8. A method for individuals to perform an analysis of their own digitized personal genomic data not stored on a centralized server, the method comprising:
(a) downloading a query from a network-accessible computer onto a personal computer or other computational device; and
(b) running the downloaded query on the individuals' own digitized personal genomic data that is not stored on a centralized server to conduct a genetic analysis of the individuals' own digitized personal genomic data.

9. The method of claim 8, wherein the network-accessible computer is a centralized server.

10. The method of claim 8, wherein, during step (b), the downloaded query is run after the personal computer or other computational device has been disconnected from the network connecting the network-accessible computer and the personal computer or other computational device.

11. The method of claim 8, wherein the digitized personal genomic data is stored on a portable storage device.

12. The method of claim 11, wherein a medical record of the individuals is also stored on the portable storage device and, during step (b), the downloaded query is run on the individuals' own digitized personal genomic data and on the medical record.

13. The method of claim 11, further comprising the step of, prior to step (b), connecting the portable storage device to the personal computer or other computational device.

14. The method of claim 11, further comprising the step of, after step (b), transmitting results of the downloaded query.

15. The method of claim 14, further comprising the step of disconnecting the portable storage device before transmitting the results of the downloaded query.

16. The method of claim 14, wherein the results of the downloaded query are transmitted to a centralized server.

17. The method of claim 14, wherein the results of the downloaded query are transmitted to an aggregating node.

18. The method of claim 14, wherein the results are transmitted on a peer-to-peer network.

19. A portable storage device comprising:
digitized personal genomic data; and
software that, when the portable storage device is connected to a computer, checks to see whether the computer is connected to a network.

20. The portable storage device of claim 19, further comprising medical information of a person whose digitized personal genomic data is stored on the portable storage device.

21. The portable storage device of claim 19, wherein the software prompts a user to disconnect a detected network connection.

22. The portable storage device of claim 19, wherein the software disconnects a detected network connection.

23. The portable storage device of claim 19, wherein the software locks the digitized personal genomic data if a network connection is detected.
